(19) United States
(12) Patent Application Publication
(10) Pub. No.: US 2008/0071927 A1
(43) Pub. Date: Mar. 20, 2008

(54) Method and system for automatic tunneling using network address translation

(76) Inventor: Min-Kyu Lee, Suwon-si (KR)

Correspondence Address: Robert E. Bushnell, Suite 300, 1522 K. Street, N.W., Washington, DC, 20005-1202, US

(21) Appl. No.: 11/878,917

(22) Filed: Jul. 27, 2007

(30) Foreign Application Priority Data
Sep. 20, 2006 (KR) 10-2006-0091373

(51) Int. Cl. G06F 15/16

(52) U.S. Cl. 709/245

(57) ABSTRACT

Provided are a method and system for automatic tunneling using Network Address Translation (NAT). The method includes the steps of: determining whether a source address in an external header of a request message received from a host located inside a NAT area is the same as a source address in an internal header of the request message; when the source address in the external header is not the same as the source address in the internal header, translating the source address in the external header into a universal source address using pre-stored NAT translation information; storing, as mapping table entries, the universal source address and a private address extracted and translated from the source address in the internal header in a mapping table and then transmitting the request message to a host located outside the NAT area; and assigning a destination address in an external header of a response message to the request message received from the host located outside the NAT area as the universal address stored in the mapping table, and then transmitting the response message.

### CLAIM OF PRIORITY

This application makes reference to, incorporates the same herein, and claims all benefits accruing under 35 U.S.C. § 119 from an application for METHOD AND SYSTEM FOR AUTOMATIC TUNNELING USING NETWORK ADDRESS TRANSLATION earlier filed in the Korean Intellectual Property Office on 20 Sep. 2006 and there duly assigned Serial No. 2006-0091373.

### BACKGROUND OF THE INVENTION

1. Field of the Invention

The present invention relates to a method and system for automatic tunneling using Network Address Translation (NAT), and more particularly, to a method and system for automatic tunneling using Network Address Translation (NAT), which allows a 6 to 4 tunnel, which is an IPv6 transition tunnel, to be used outside a Network Address Translation (NAT) area.

2. Description of the Related Art

In Transmission Control Protocol/Internetworking Protocol (TCP/IP) that is an inter-network connection protocol, a network layer protocol is currently operating as Internet Protocol version 4 (IPv4). IPv4 provides host-to-host communication between systems on the Internet. Even though IPv4 is well designed, some problems arise when applied to data communication (e.g., Internet communication) which has been continuously developed since the 3′ advent of IPv4 (i.e., 1970s).

To solve such problems, Internet Protocol version 6 (IPv6), known as “Internetworking Protocol, next generation (IPng)” was proposed and standardized. In IPv6, many portions of Internet protocol have been modified to accommodate a greatly developing Internet. For example, the format and length of an IP address was modified with the format of a packet, related protocols (e.g., Internet Control Message Protocol; ICMP) was modified, and other protocols such as Address Resolution Protocol (ARP), Reverse Address Resolution Protocol (RARP), and Internet Group Management Protocol (IGMP) were deleted from a network layer or included in the Internet Control Message Protocol (ICMP). Also, routing protocols (e.g., Routing Information Protocol (RIP), Open Shortest Path First (OSPF), etc.) were somewhat modified to accommodate such changes.

After IPv6 was proposed and standardized, more IPv6-based systems have been developed. However, because there are a great number of systems on the Internet, rapid transition from IPv4 to IPv6 cannot take place. That is, it takes much time for all systems on the Internet to transition from IPv4 to IPv6. And, the transition must gradually take place so that any problems do not arise between IPv4 systems and IPv6 systems.

This strategy was designed by the Internet Engineering Task Force (IETF), and includes a dual stack based method, a header translation method, and a tunneling method.

In the dual stack based method, all hosts use dual stack protocol before transitioning to IPv6. That is, both IPv4 and IPv6 will operate until all systems on the Internet use IPv6.

The header translation method is useful when most of Internet systems use IPv6, but some use IPv4. When a sender desires to use IPv6 but a receiver does not understand it, the sender translates a header of an IPv6 packet into an IPv4 header for transmission.

The tunneling method is used when two IPv6-based computers must transmit an IPv4 area for communication with each other. With the tunneling method, an IPv6 packet is encapsulated into an IPv4 packet upon entering the IPv4 area and decapsulated upon leaving the IPv4 area.

In particular, tunnels may be greatly classified into a configured tunnel and an automatic tunnel. Examples of the automatic tunnel include 6 to 4, and Intra-Site Automatic Tunnel Address Protocol (ISATAP). The present invention is directed to the tunneling method, and more particularly, to a 6 to 4 automatic tunneling method.

This 6 to 4 tunneling mechanism assigns a 6 to 4 IPv6 prefix to an IPv6 dedicated site having one or more unique IPv4 addresses so that automatic tunneling with an external IPv6 network is accomplished. In the 6 to 4 tunneling mechanism, an IPv6 universal address including an IPv4 address in an interface identifier, such as “2002:IPv4address::/64”, is used. For example, when an IPv4 address of an 6 to 4 router is 10.1.1.1, an IPv6 address of the 6 to 4 router may be set to “global 6 to 4 address: 2002:0a01:0101::1/64”.

Meanwhile, Network Address Translation (NAT) is a translation scheme for translating a private address to a universal address and vice versa, as defined in RFC3022 (Network Working Group Request for Comments 3022; Traditional IP Network Address Translator (Traditional NAT)). A private address is used inside the Network Address Translation (NAT) area and a universal address is used outside the Network Address Translation (NAT) area. Network Address Translation (NAT) equipment corresponds the addresses to each other. The Network Address Translation (NAT) is originally intended to cope with insufficient universal IPv4 addresses, but also provides security.

In the 6 to 4 automatic tunneling system, when one 6 to 4 router is located inside the Network Address Translation (NAT) area and another is located outside the Network Address Translation (NAT) area, an ICMPv6 (RFC1885 (Internet Control Message Protocol (ICMPv6) for the Internet Protocol Version 6 (IPv6))) request message from the IPv6 host inside the Network Address Translation (NAT) area normally reaches the IPv6 host located outside the Network Address Translation (NAT) area, but an ICMPv6 (Internet Control Message Protocol version 6) response message to the ICMPv6 request message from the IPv6 host located outside the Network Address Translation (NAT) area cannot reach the IPv6 host inside the Network Address Translation (NAT) area. This is because the IPv4 destination address that the 6 to 4 router, located outside the Network Address Translation (NAT) area, uses upon encapsulating the ICMPv6 response message is a private address of the 6 to 4 router located inside the Network Address Translation (NAT) area, and the 6 to 4 router outside the Network Address Translation (NAT) area has no routing information for the IPv4 address.

As described above, bidirectional communication between IPv6 hosts using the Network Address Translation (NAT) is impossible. To solve this problem, Network Address Translation (NAT) equipment separately processes all packets encapsulated in a 6 to 4 tunnel (using a 6 to 4 ALG), as disclosed in Korean Patent Application No. 10-2005-7008519. In this patent application, when Network Address Translation (NAT) equipment receives an encapsulated packet from a 6 to 4 router, it modifies the packet so that not only a source address of an IPv4 packet but also an IPv6 source address includes an IPv4 public address. In this manner, the Network Address Translation (NAT) equipment must check all packets to confirm whether they are encapsulated in a 6 to 4 scheme and modify the 6 to 4 packet. This causes transmission delay and increases load on the Network Address Translation (NAT) equipment.

### SUMMARY OF THE INVENTION

It is an object of the present invention to provide a method and system for automatic tunneling using Network Address Translation (NAT) which are capable of providing bidirectional communication through a 6 to 4 tunnel, even when a IPv6 host at a sending side is inside a Network Address Translation (NAT) area and a IPv6 host at a receiving side is outside the Network Address Translation (NAT) area.

It is another object of the present invention to provide a method and system for automatic tunneling using Network Address Translation (NAT) which are capable of using a 6 to 4 scheme in a Network Address Translation (NAT) area without modification of Network Address Translation (NAT) equipment and with minimized transmission delay.

A first aspect of the present invention provides a method for automatic tunneling using Network Address Translation (NAT) between networks having different address formats, the method comprising the steps of: determining whether a source address in an external header of a request message received from a host located inside a Network Address Translation (NAT) area is the same as a source address in an internal header of the request message; when the source address in the external header is not the same as the source address in the internal header, translating the source address in the external header into a universal source address using pre-stored NAT (Network Address Translation) translation information; storing the universal source address and a private address extracted and translated from the source address in the internal header, as mapping table entries, in a mapping table and then transmitting the request message to a host located outside the Network Address Translation (NAT) area; and assigning the universal address stored in the mapping table as a destination address in an external header of a response message to the request message received from the host located outside the Network Address Translation (NAT) area, and then transmitting the response message.

In the step of storing, as mapping table entries, the universal source address and a private address extracted and translated from the source address in the internal header in a mapping table, and then transmitting the request message to a host located outside the Network Address Translation (NAT) area, wherein the universal source address in the external header may be an IPv4 universal address of the router located inside the Network Address Translation (NAT) area, and the private address extracted and translated from the source address in the internal header may be an IPv4 private address of the router.

The method may further comprise the step of: when the response message is received, translating, by the Network Address Translation (NAT), the destination address in the external header of the message into a private address and transmitting the message to the router located inside the Network Address Translation (NAT) area.

In the step of storing, as mapping table entries, the universal source address and a private address extracted and translated from the source address in the internal header in a mapping table, and then transmitting the request message to a host located outside the Network Address Translation (NAT) area, the mapping table may comprise a field for storing the universal source address in the external header; a field for storing the private address extracted and translated from the source address in the internal header; and a deletion timer field for storing time information indicating a time when the stored mapping table entries are to be deleted after a predetermined time elapses.

The time information stored in the deletion timer field upon storing the mapping table entries may be set according to a set timer value of Network Address Translation (NAT) equipment.

The stored mapping table entries may be automatically deleted when the time information value stored in the deletion timer field becomes ‘0’.

A second aspect of the present invention provides a system for automatic tunneling using Network Address Translation (NAT) between networks having different address formats, the system comprising a router located outside a Network Address Translation (NAT) area for, when a source address in an external header of a request message received from a host located inside the Network Address Translation (NAT) area is not the same as a source address in an internal header of the request message, translating the source address in the external header into a universal source address using pre-stored NAT (Network Address Translation) translation information, and storing, as mapping table entries, the universal source address and a private address extracted and translated from the source address in the internal header in a mapping table, assigning the universal address stored in the mapping table as a destination address in an external header of a response message to the request message received from the host located outside the Network Address Translation (NAT) area, and then transmitting the response message.

The router may comprise a packet transceiver for transmitting and receiving a message to and from hosts located inside and outside the Network Address Translation (NAT) area; an address comparator for receiving the request message from the Network Address Translation (NAT) via the packet transceiver and comparing the source address in the external header of the received request message with the source address in the internal header of the request message; a controller for determining whether address translation of the request message by the Network Address Translation (NAT) is made based on the address comparison result from the address comparator; a mapping table database (DB) for storing, under control of the controller, the universal source address in the external header of the request message and the private address extracted and translated from the source address in the internal header when the controller determines that the address translation of the request message by the Network Address Translation (NAT) is made; and a response message generator for assigning, under control of the controller, the universal address mapped to the private address stored in the mapping table DB as the destination address in the external header of the response message to the request message, to generate the response message to be transmitted to the Network Address Translation (NAT).

The universal source address in the external header stored in the mapping table DB may be an IPv4 universal address of the router located inside the Network Address Translation (NAT) area, and the private address extracted and translated from the source address in the internal header may be an IPv4 private address of the router located inside the Network Address Translation (NAT) area.

The mapping table stored in the mapping table DB may comprise a field for storing the universal source address in the external header; a field for storing the private address extracted and translated from the source address in the internal header; and a deletion timer field for storing time information indicating a time when the stored mapping table entries are to be deleted after a predetermined time elapses.

The time information stored in the deletion timer field upon storing the mapping table entries may be set according to a set timer value of Network Address Translation (NAT) equipment.

The stored mapping table entries may be automatically deleted when the time information value stored in the deletion timer field becomes ‘0’.

A third aspect of the present invention provides a routing device using Network Address Translation (NAT) between networks having different address formats, the router device comprising: a packet transceiver for transmitting and receiving a message to and from hosts located inside and outside a Network Address Translation (NAT) area; an address comparator for receiving a request message from the Network Address Translation (NAT) via the packet transceiver and comparing a source address in an external header of the received request message with a source address in an internal header of the request message; a controller for determining whether address translation of the request message by the Network Address Translation (NAT) is made based on the address comparison result from the address comparator; a mapping table DB for storing, under control of the controller, the universal source address in the external header of the request message and a private address extracted and translated from the source address in the internal header when the controller determines that the address translation of the request message by the Network Address Translation (NAT) is made; and a response message generator for assigning, under control of the controller, the universal address mapped to the private address stored in the mapping table DB as a destination address in an external header of a response message to the request message, to generate the response message to be transmitted to the Network Address Translation (NAT).

The universal source address in the external header stored in the mapping table DB may be an IPv4 universal address of the router located inside the Network Address Translation (NAT) area, and the private address extracted and translated from the source address in the internal header may be an IPv4 private address of the router located inside the Network Address Translation (NAT) area.

The mapping table stored in the mapping table DB may comprise a field for storing the universal source address in the external header; a field for storing the private address extracted and translated from the source address in the internal header; and a deletion timer field for storing time information indicating a time when the stored mapping table entries are to be deleted after a predetermined time elapses.

The time information stored in the deletion timer field upon storing the mapping table entries may be set according to a set timer value of Network Address Translation (NAT) equipment.

The stored mapping table entries may be automatically deleted when the time information value stored in the deletion timer field becomes ‘0’.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a schematic diagram illustrating an example of a tunneling process in an IPv6 transition network structure;

FIG. 2 illustrates a 6 to 4 IPv6 address format;

FIG. 3 is a diagram illustrating an example in which a packet is transmitted, encapsulated, and decapsulated at a 6 to 4 site;

FIG. 4 is a diagram illustrating an example in which an ICMPv6 (Internet Control Message Protocol for the Internet Protocol Version 6) message is transmitted through a 6 to 4 tunnel in a network including a Network Address Translation (NAT) translator;

FIG. 5 is a diagram illustrating another example in which an ICMPv6 message is transmitted through a 6 to 4 tunnel in a network including a Network Address Translation (NAT) translator;

FIG. 6 is a diagram illustrating an example in which an ICMPv6 message is transmitted through a 6 to 4 tunnel in a network including a Network Address Translation (NAT) translator according to the present invention; and

FIG. 7 is a block diagram illustrating a 6 to 4 router located outside a Network Address Translation (NAT) area of FIG. 6.

### DETAILED DESCRIPTION OF THE INVENTION

Hereinafter, exemplary embodiments of the present invention will be described in detail with reference to the accompanying drawings. For the sake of clarity and conciseness, matters related to the invention that are well known in the art will not be described.

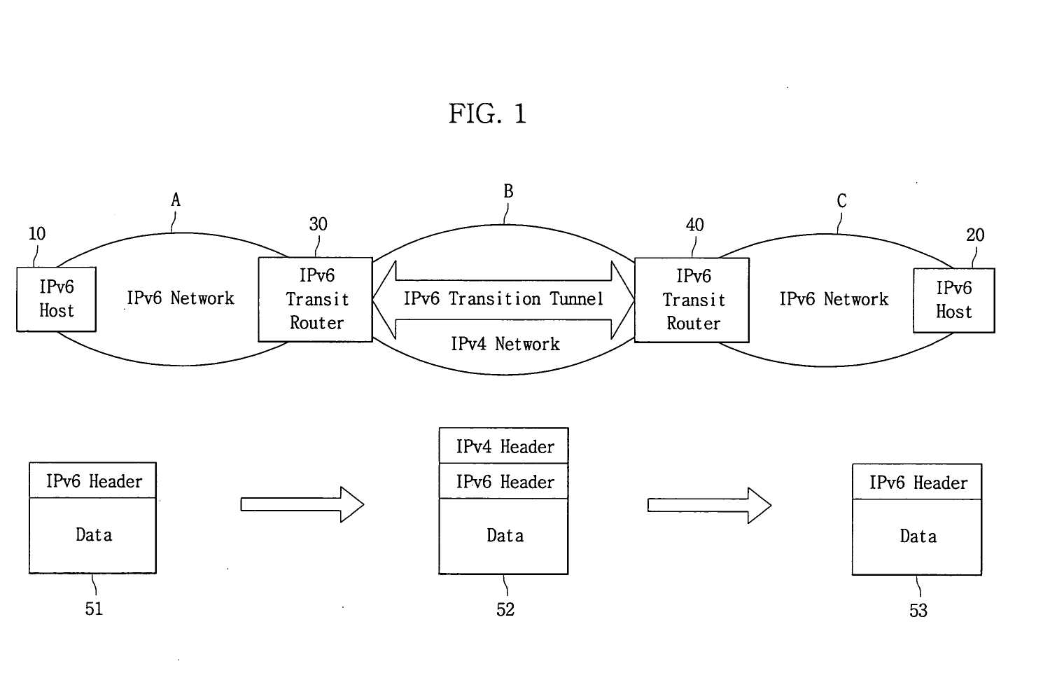

FIG. 1 is a schematic diagram illustrating an example of a tunneling process in an IPv6 transition network structure.

An example in which an IPv6 host 10 connected to an IPv6 network A transmits data to an IPv6 host 20 connected to another IPv6 network C via an IPv4 network B is shown in FIG. 1.

Referring to FIG. 1, the IPv6 host 10 transmits an IPv6 packet 51, which is encapsulated by IPv6, to the IPv6 network A. An IPv6/IPv4 (6 to 4) router (IPv6 transmit router) 30, located at a boundary between the IPv6 network A and the IPv4 network B, encapsulates the IPv6 packet 51 using IPv4 and transmits it to an IPv4/IPv6 router (IPv6 transmit router) 40 located at a boundary between the IPv4 network B and the IPv6 network C. That is, the IPv6/IPv4 router 30 adds an IPv4 header to the IPv6 packet 51 and transmits the resultant packet 52 to the IPv4 network B.

When the packet 52 encapsulated by IPv4 is received, the IPv6/IPv4 router 40 decapsulates the packet 52 and transmits the resultant IPv6 packet 53 without IPv4 header to the IPv6 network C. That is, the IPv6/IPv4 router 40 removes the IPv4 header, which is added for allowing the packet to transmit the IPv4 network B, from the packet 52 and transmits the resultant IPv6 packet 53 to the IPv6 network C. As a result, the IPv6 host 20 can receive the IPv6 packet 53 without the IPv4 header.

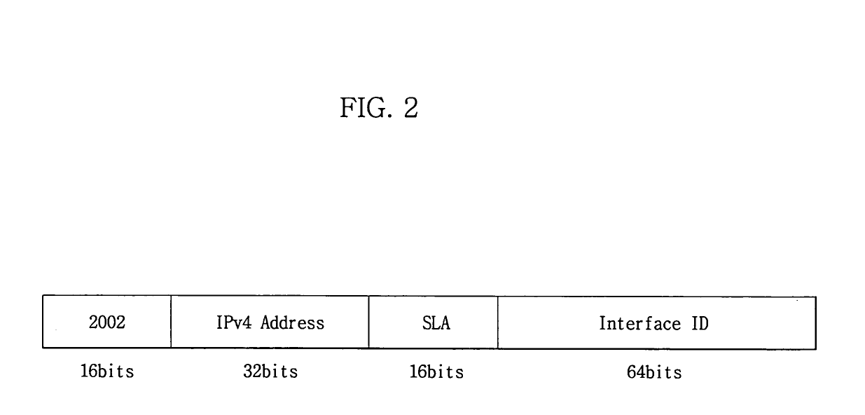

FIG. 2 illustrates a 6 to 4 IPv6 address format.

As shown in FIG. 2, the 6 to 4 IPv6 address format includes a “2002 (16 bits)” portion that is common to private and universal address formats, an interface identifier portion having an IPv4 address portion and a Site Level Aggregator (SLA) portion, and an interface ID portion.

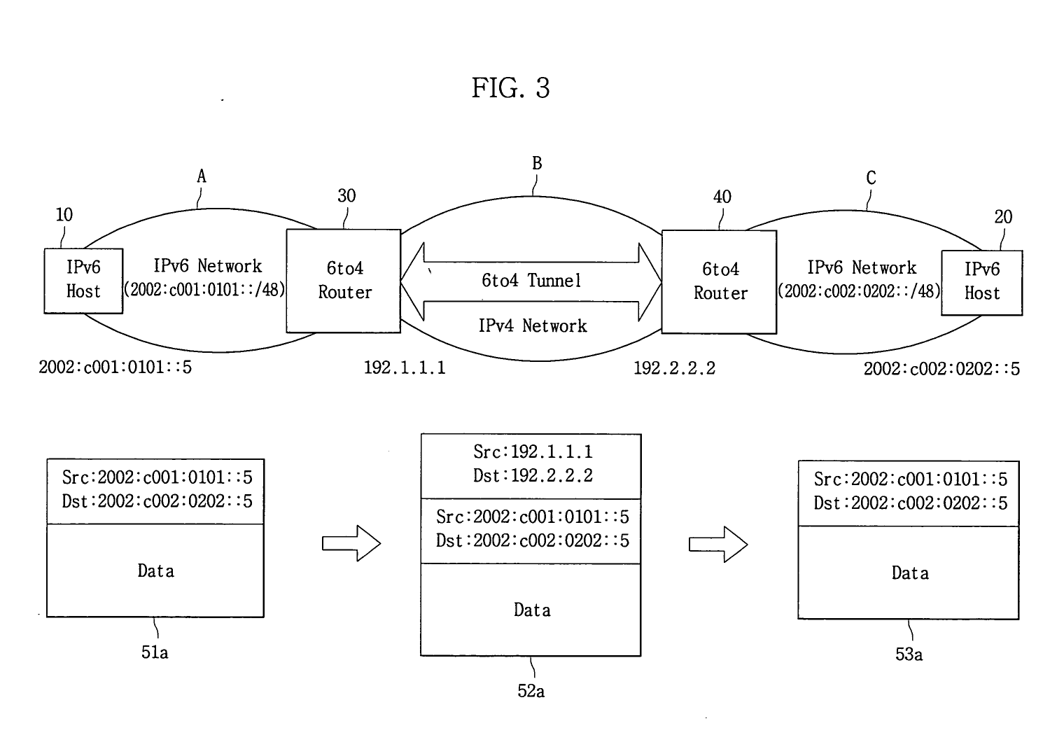

FIG. 3 is a diagram illustrating an example in which a packet is transmitted, encapsulated, and decapsulated at a 6 to 4 site.

An example in which an IPv6 address of an IPv6 host 10 is ‘2002:c001:0101::5’ and an IPv6 address of an IPv6 host 20 is ‘2002:c002:0202::5’ is shown in FIG. 3. That is, a 6 to 4 tunneling process in which the IPv6 host 10 having the IPv6 address of ‘2002:c001:0101::5’ transmits an IPv6 packet to the IPv6 host 20 having the IPv6 address of ‘2002:c002:0202::5’ via an IPv4 network B is illustrated.

Referring to FIG. 3, the IPv6 host 10 IPv6-encapsulates a packet to be transmitted, by adding an IPv6 header to the packet. The IPv6 header includes a source (“Src”) address and a destination (“Dst”) address. In the example of FIG. 3, since the source Src of the packet to be transmitted is the IPv6 host 10 and the destination Dst is the IPv6 host 20, the IPv6 header of the IPv6-encapsulated data 51a includes the address of the IPv6 host 10 (2002:c001:0101::5) and the address of the IPv6 host 20 (2002:c002:0202::5). The IPv6 host 10 transmits the IPv6-encapsulated data 51a to an IPv6/IPv4 router 30 via an IPv6 network A.

The IPv6/IPv4 router 30 IPv4-encapsulates the data 51a by adding an IPv4 header to the data 51a. The source address of the IPv4 header is ‘192.1.1.1’ that is an IPv4 address of the IPv6/IPv4 router 30, and the destination address is ‘192.2.2.2’ that is an IPv4 address of an IPv6/IPv4 router 40.

Specifically, an IPv4 address included in an IPv6 destination address is used as the destination address of the IPv4 packet which enters an IPv4 area, and an IPv4 address included in an IPv6 source address is used as the source address of the IPv4 packet which enters the IPv4 area.

The IPv6/IPv4 router 30 transmits the encapsulated packet 52a with the IPv4 header to the IPv6/IPv4 router 40 via the IPv4 network B according to the source address and destination address information of the IPv4 header.

The IPv6/IPv4 router 40 decapsulates the received packet 52a and transmits the resultant packet 53a to the IPv6 network C. That is, the IPv6/IPv4 router 40 removes the IPv4 header from the packet 52a and transmits the resultant packet 53a to the IPv6 host 20 via the IPv6 network C, so that the IPv6 host 20 receives an IPv6 packet 53a without the IPv4 header.

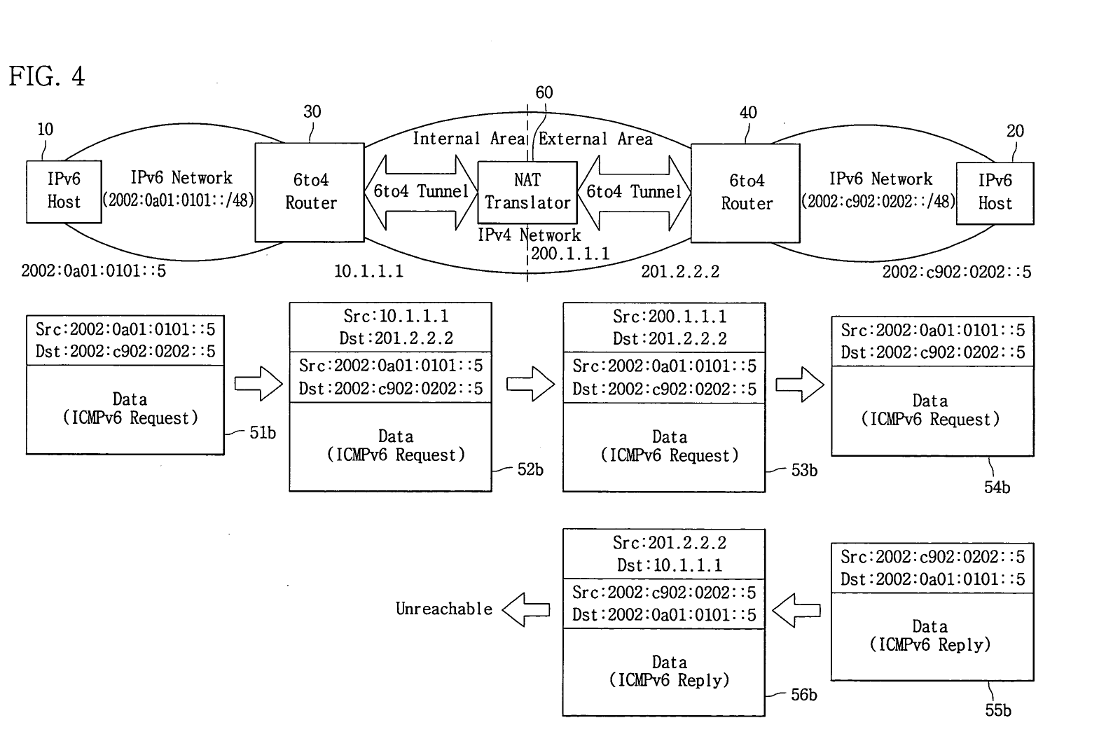

FIG. 4 is a diagram illustrating an example in which an ICMPv6 message is transmitted through a 6 to 4 tunnel in a network including a Network Address Translation (NAT) translator.

As shown in FIG. 4, an IPv6 host 10 adds an IPv6 header including “Src:2002:0a01:0101::5” and “Dst:2002:c902:0202::5”, to data to be transmitted, and transmits the resultant ICMPv6 (Internet Control Message Protocol for the Internet Protocol Version 6) request message 51b to an IPv6/IPv4 router 30.

The IPv6/IPv4 router 30 extracts IPv4 addresses from “Src:2002:0a01:0101::5” and “Dst:2002:c902:0202::5” in the IPv6 header, encapsulates the data by adding an IPv4 header having the extracted IPv4 address information to the data, and transmits the encapsulated ICMPv6 request message 52b to a Network Address Translation (NAT) translator 60.

Upon receipt of the ICMPv6 request message 52b from the IPv6/IPv4 router 30, the Network Address Translation (NAT) translator 60 translates the source address (Src:10.1.1.1) that is a private address in the IPv4 header of the ICMPv6 request message 52b into a universal address (Src:200.1.1.1) using an internal mapping table, and transmits an ICMPv6 request message 53b having the translated IPv4 header to the IPv6/IPv4 router 40.

The IPv6/IPv4 router 40 decapsulates the encapsulated ICMPv6 request message 53b received from the Network Address Translation (NAT) translator 60 and transmits the decapsulated message 54b to an IPv6 host 20.

Upon receipt of the decapsulated message 54b from the IPv6/IPv4 router 40, the IPv6 host transmits an ICMPv6 response (reply) message 55b with a source address (Src:2002:c902:0202::5) and a destination address (Dst:2002:0a01:0101::5), which are reversed, to the IPv6/IPv4 router 40.

When the ICMPv6 response message 55b is received from the IPv6 host 20, the IPv6/IPv4 router 40 extracts IPv4 addresses from “Src:2002:c902:0202::5” and “Dst:2002:0a01:0101::5” in the IPv6 header of the ICMPv6 response message 55b, translates the IPv4 addresses into IPv4 address information “Src:201.2.2.2”, “Dst:10.1.1.1”, adds an IPv4 header having the IPv4 address information to the data, and transmits the resultant encapsulated ICMPv6 response message 56b to the Network Address Translation (NAT) translator 60.

The Network Address Translation (NAT) translator 60, however, cannot receive the ICMPv6 response message 56b from the IPv6/IPv4 router 40. This is because the IPv4 destination address that the IPv6/IPv4 router 40, located outside a Network Address Translation (NAT) area, uses upon encapsulating the ICMPv6 response message is the private address (Dst:10.1.1.1) of the 6 to 4 router 30 located inside the Network Address Translation (NAT) area, and the IPv6/IPv4 router 40 has no routing information associated with the IPv4 address. Since bidirectional communication is impossible between the IPv6 hosts located outside and inside the Network Address Translation (NAT) area, the 6 to 4 automatic tunneling scheme uses the Network Address Translation (NAT).

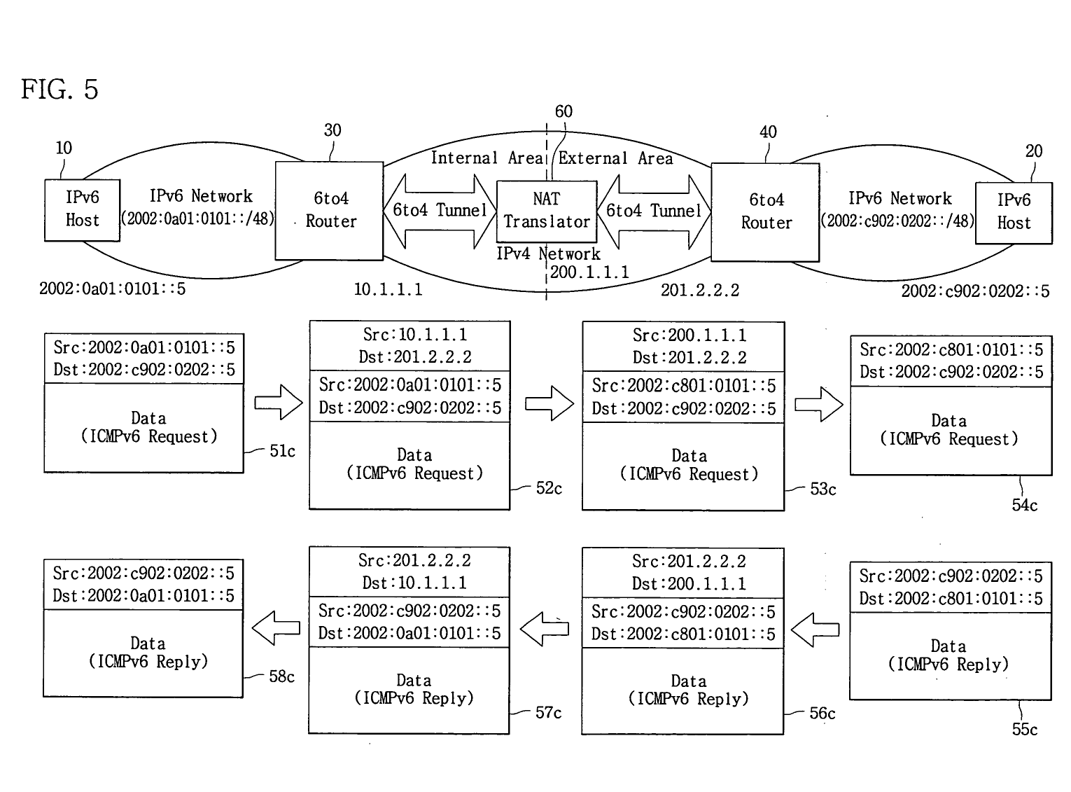

FIG. 5 is a diagram illustrating another example in which an ICMPv6 message is transmitted through a 6 to 4 tunnel in a network including a Network Address Translation (NAT) translator.

As shown in FIG. 5, an IPv6 host 10 adds an IPv6 header including “Src:2002:0a01:0101::5” and “Dst:2002:c902:0202::5”, to data to be transmitted, and transmits the resultant ICMPv6 request message 51c to an IPv6/IPv4 router 30.

The IPv6/IPv4 router 30 extracts IPv4 addresses from “Src:2002:0a01:0101::5” and “Dst:2002:c902:0202::5” in the IPv6 header, encapsulates the data by adding an IPv4 header having the extracted IPv4 address information to the data, and transmits the encapsulated ICMPv6 request message 52c to a Network Address Translation (NAT) translator 60.

Upon receipt of the ICMPv6 request message 52c from the IPv6/IPv4 router 30, the Network Address Translation (NAT) translator 60 translates a source address (Src: 10.1.1.1) that is a private address in the IPv4 header of the ICMPv6 request message 52c into a universal address (Src:200.1.1.1) using an internal mapping table, translates an IPv4 address portion (0a01:0101) of the source address in the IPv6 header into c801:0101 that is obtained by translating the source address (Src:200.1.1.1) of the IPv4 header into a hexadecimal value, and transmits an ICMPv6 request message 53c having the translated IPv4 header to an IPv6/IPv4 router 40.

The IPv6/IPv4 router 40 decapsulates the encapsulated ICMPv6 request message 53c received from the Network Address Translation (NAT) translator 60 and transmits the decapsulated message 54c to an IPv6 host 20.

Upon receipt of the decapsulated message 54c from the IPv6/IPv4 router 40, the IPv6 host transmits an ICMPv6 response (reply) message 55c with a source address (Src:2002:c902:0202::5) and a destination address (Dst:2002:0a01:0101::5), which are reversed, to the IPv6/IPv4 router 40.

When the ICMPv6 response message 55c is received from the IPv6 host 20, the IPv6/IPv4 router 40 extracts IPv4 addresses from “Src:2002:c902:0202::5” and “Dst:2002:0a01:0101::5” in the IPv6 header of the ICMPv6 response message 55c, translates the IPv4 addresses into IPv4 address information (“Src:201.2.2.2”, “Dst:200.1.1.1”), adds an IPv6 header having the IPv4 address information to the data, and transmits the resultant encapsulated ICMPv6 response message 56c to the Network Address Translation (NAT) translator 60.

Upon receipt of the ICMPv6 response message 56c from the IPv6/IPv4 router 40, the Network Address Translation (NAT) translator 60 transmits an destination address (Dst:200.1.1.1) that is a universal address in the IPv4 header of the ICMPv6 response message 56c into a private address (Dst:10.1.1.1) using an internal mapping table, translates an IPv4 address portion (c801:0101) of the destination address in the IPv6 header into 0a01:0101 that is obtained by translating the destination address 10.1.1.1 in the IPv4 header into a hexadecimal value, and transmits an ICMPv6 response message 57c having the translated IPv6/IPv4 header to the IPv6/IPv4 router 30.

The IPv6/IPv4 router 30 decapsulates the encapsulated ICMPv6 response message 57c received from the Network Address Translation (NAT) translator 60 and transmits the decapsulated response message 58c to the IPv6 host 10.

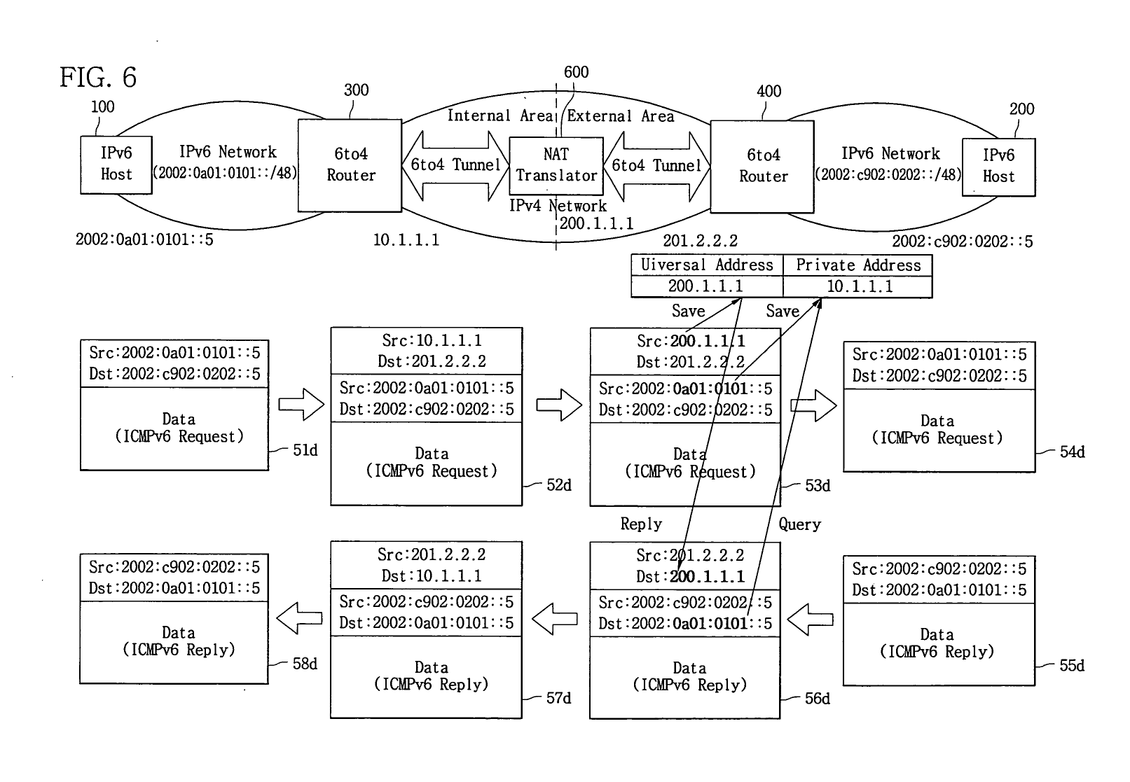

FIG. 6 is a diagram illustrating an example in which an ICMPv6 (Internet Control Message Protocol for the Internet Protocol Version 6) message is transmitted through a 6 to 4 tunnel in a network including a Network Address Translation (NAT) translator according to the present invention.

FIG. 6 illustrates a process of checking whether a message received by a 6 to 4 router transmit Network Address Translation (NAT), extracting and storing NAT (Network Address Translation) translation information from the received message, and using the stored NAT (Network Address Translation) translation information so that bidirectional communication between the 6 to routers is possible even through a 6 to 4 tunnel.

As shown in FIG. 6, an IPv6 host 100 adds an IPv6 header including “Src:2002:0a0:0101::5” and “Dst:2002:c902:0202::5” to data to be transmitted, and transmits the resultant ICMPv6 request message 51d to an IPv6/IPv4 (6 to 4) router 300.

The 6 to 4 router 300 extracts IPv4 addresses from “Src:2002:0a01:0101::5” and “Dst:2002:c902:0202::5” in the IPv6 header, translates the IPv4 addresses into IPv4 address information (Src:10.1.1.11, Dst:201.2.2.2), encapsulates the data by adding an IPv4 header having IPv4 address information (Src:10.1.1.1, Dst:201.2.2.2) to the data, and transmits the encapsulated ICMPv6 request message 52d to a Network Address Translation (NAT) translator 600.

Upon receipt of the ICMPv6 request message 52d from the IPv6/IPv4 router 300, the Network Address Translation (NAT) translator 600 translates the source address (Src:10.1.1.1), that is a private address in the IPv4 header of the ICMPv6 request message 52d, into a universal address (Src:200.1.1.1) using an internal mapping table, and transmits an ICMPv6 request message 53d having the translated IPv4 header to an IPv6/IPv4 (6 to 4) router 400.

When the ICMPv6 request message 53d is received, the 6 to 4 router 400 checks whether the ICMPv6 request message 53d is received through the Network Address Translation (NAT). When the packet is not received through the Network Address Translation (NAT), the 6 to 4 router 400 encapsulates the received 6 to 4 packet upon transmitting a response message to the 6 to 4 packet using the traditional method.

However, when the packet is received through the Network Address Translation (NAT), for bidirectional communication, the 6 to 4 router 400 extracts NAT (Network Address Translation) translation information from the 6 to 4 packet and stores it in an internal 6 to 4 routing table. Then, upon transmitting the response message to the received 6 to 4 packet, the 6 to 4 router 400 encapsulates the 6 to 4 packet using the NAT (Network Address Translation) translation information stored in the 6 to 4 routing table.

Here, the check as to whether the packet is received through the Network Address Translation (NAT), or not, may be based on a result of comparing external header information with internal header information of the encapsulated message.

Specifically, when the encapsulated 6 to 4 packet is received, the 6 to 4 router 400 checks an IPv4 source address from an external header and an IPv6 source address from an internal header. Then, the 6 to 4 router 400 compares an IPv4 address included in the IPv6 source address in the internal header with the IPv4 source address in the external header. When they are the same, the 6 to 4 router 400 determines that the packet does not transmit the Network Address Translation (NAT), and when they differ, it recognizes the IPv4 source address in the external header as being changed by the Network Address Translation (NAT). When the received 6 to 4 packet transmits the Network Address Translation (NAT), the 6 to 4 router 400 stores the IPv4 header translation information in the following table. IPv4 address information before translation can be obtained by extracting the IPv4 address portion of the IPv6 source address from the internal header.

TABLE 1

| Universal IP address | Private IP address | Deletion timer, sec |
|---|---|---|
| 200.1.1.1 | 10.1.1.1 | 300 |

In Table 1, the deletion timer indicates a time when entries of the Network Address Translation (NAT) address mapping table stored for capsulation are to be deleted after a predetermined time elapses. This deletion timer is set to a default value (e.g., “300” seconds) when a new entry is stored, and then the value decrements by one per second. When the deletion timer value becomes ‘0’, the entry is automatically deleted. In this manner, the deletion timer serves to delete an entry that is not used for a predetermined period of time.

When the NAT translation information of the 6 to 4 packet received through the Network Address Translation (NAT) is present in the mapping table, an existing entry is changed and the deletion timer is updated to a default value.

In particular, Network Address Translations (NATs) may be classified into a static Network Address Translation (NAT) and a dynamic Network Address Translation (NAT) depending on a universal address-private address translating scheme. In the static Network Address Translation (NAT), the universal address and the private address have a one-to-one correspondence relationship. The dynamic Network Address Translation (NAT) is used when universal addresses are not sufficient to support all hosts.

In the dynamic Network Address Translation (NAT), when data from a host having a private address transmits the Network Address Translation (NAT) area through Network Address Translation (NAT) equipment, the private address corresponds with an universal address. This correspondence relationship is maintained for a predetermined time. After the predetermined time elapses, the correspondence relationship is deleted and the host cannot be accessed from an area outside the Network Address Translation (NAT) area.

When the static Network Address Translation (NAT) is used, the one-to-one correspondence relationship is maintained, and accordingly, the Network Address Translation (NAT) mapping table need not be changed. Therefore, the deletion timer on the table may be set to a sufficiently great default value.

In the dynamic Network Address Translation (NAT) applied to the present invention, however, since the correspondence relationship between the universal address and the private address is deleted after a predetermined time elapses, the correspondence relationship experiences a change. A maintenance time of the correspondence relationship in the dynamic Network Address Translation (NAT) is set by the Network Address Translation (NAT) equipment. As the maintenance time is shorter, the correspondence relationship is modified earlier. Accordingly, the default value of the deletion timer on the Network Address Translation (NAT) mapping table may be set according to the maintenance the time. This allows for maintenance of a correspondence between the table information stored in the 6 to 4 router and the Network Address Translation (NAT) correspondence relationship.

After producing the routing table for storing the translated universal IPv4 address (Src:200.1.1.1), the private IPv4 address (0a01:0101) of the source address (Src:2002:0a01:0101::5) in the IPv6 header, and the deletion timer time (e.g., ‘300’) information, the 6 to 4 router 400 decapsulates the encapsulated ICMPv6 request message 53d received from the Network Address Translation (NAT) translator 600, and transmits the decapsulated message 54d to the IPv6 host 200.

When the decapsulated message 54d is received from the 6 to 4 router 400, the IPv6 host 200 transmits an ICMPv6 response (reply) message 55d having a source address (Src:2002:c902:0202::5) and a destination address (Dst:2002:0a01:0101::5), which are reversed, to the 6 to 4 router 400.

The 6 to 4 router 400 then receives and encapsulates the ICMPv6 response message 55d from the IPv6 host 200. In this case, the 6 to 4 router 400 detects a universal address corresponding to the private address of the 6 to 4 router 300 located inside the Network Address Translation (NAT) area using the NAT (Network Address Translation) translation information on the internal routing table, and uses it as the destination address of the external header of the response message.

That is, the 6 to 4 router 400 queries the internal routing table to recognize the universal IPv4 address for “0a01:0101”, corresponding to the IPv4 address, of the destination address “Dst:2002:0a01:0101::5” in the IPv6 header, and receives a universal address “200.1.1.1” mapped to a private IPv4 address “10.1.1.1” for “0a01:0101”, as a reply.

The 6 to 4 router 400 extracts “c902:0202” corresponding to the IPv4 address from the source address (Src:2002:c902:0202::5) in the IPv6 header, translates it into a universal IPv4 address, i.e., “201.2.2.2”, selects “201.2.2.2” as the source address of the IPv4 header, and selects the universal IPv4 address “200.1.1.1” from the internal routing table as the destination address of the IPv4 header.

Accordingly, the 6 to 4 router 400 can transmit the ICMPv6 response message 56d, to which the IPv4 header is added by the routing table, to the Network Address Translation (NAT) translator 600.

The Network Address Translation (NAT) translator 600 translates the universal IPv4 destination address (Dst:200.1.1.1) in the IPv4 header of the ICMPv6 response message 56d received from the 6 to 4 router 400, into a private IPv4 address (Dst: 10.1.1.1), and transmits the translated CMPv6 response message 57d to the 6 to 4 router 300.

The 6 to 4 router 300 decapsulates the encapsulated ICMPv6 response message 57d received from the Network Address Translation (NAT) translator 600 and transmits the decapsulated message 58d to the IPv6 host 100.

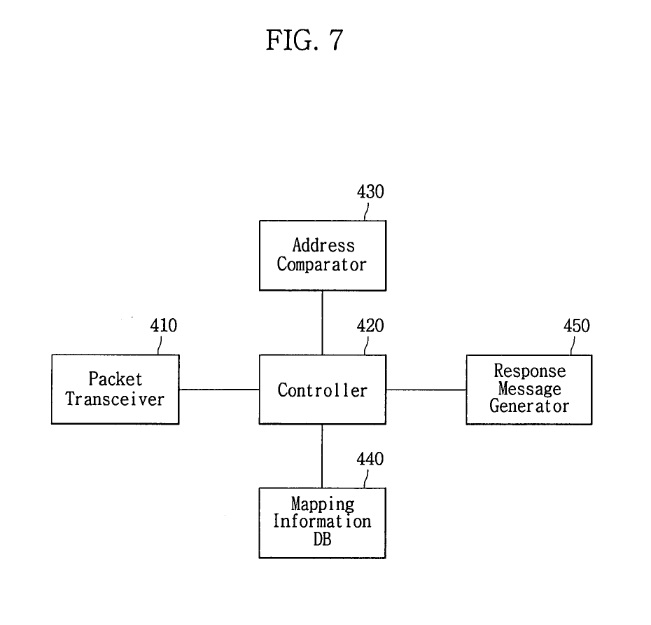

FIG. 7 is a block diagram illustrating a 6 to 4 router located outside a Network Address Translation (NAT) area of FIG. 6.

Referring to FIG. 7, the 6 to 4 router 400 of the present invention comprises a packet transceiver 410, a controller 420, an address comparator 430, a mapping information database (DB) 440, and a response message generator 450.

The packet transceiver 410 transmits and receives data to and from hosts located inside and outside the Network Address Translation (NAT) area.

When the ICMPv6 request message is received from the Network Address Translation (NAT) translator via the packet transceiver 410, the controller 420 delivers the received ICMPv6 request message to the address comparator 430.

The address comparator 430 compares address information of an internal header (IPv6 header) of the ICMPv6 request message delivered by the controller 420 with address information of an external header (IPv4 header) of the message. That is, the address comparator 430 compares the source address included in the internal header (IPv6 header) of the ICMPv6 request message with the source address in the external header (IPv4 header), and reports the comparison result to the controller 420.

The controller 420 checks the address comparison result from the address comparator 430. When the source address included in the internal header of the ICMPv6 request message is the same as the source address in the external header, the controller 420 determines that address translation by the Network Address Translation (NAT) translator is not made. When the source address in the internal header is not the same as the source address in the external header, the controller 420 determines that the source address in the external header is translated by the Network Address Translation (NAT) translator.

In particular, when the source address included in the internal header of the ICMPv6 request message is the same as the source address in the external header, the controller 420 stores the source address included in the internal header of the ICMPv6 request message and the source address included in the external header in the mapping information DB 440.

Under control of the controller 420, the mapping information DB 440 stores an IPv4 universal source address in the external header of the ICMPv6 request message, an IPv4 source private address in the internal header, and deletion timer time information in a table format. As described above, the deletion timer indicates a time when entries of the Network Address Translation (NAT) address mapping table stored for capsulation are to be deleted after a predetermined time elapses.

The response message generator 450 generates an ICMPv6 response message to the ICMPv6 request message, which is received through the Network Address Translation (NAT), under control of the controller 420.

In other words, when the ICMPv6 request message is received from the IPv6 host located outside the Network Address Translation (NAT) area, the controller 420 queries the mapping information DB 440 to obtain the universal address corresponding to the private address of the 6 to router located inside the Network Address Translation (NAT) area, unlike a conventional scheme in which an IPv4 address is extracted and translated from a destination address in an IPv6 header of data.

When the universal address corresponding to the private address of the 6 to 4 router located inside the Network Address Translation (NAT) area is received as a reply from the mapping information DB 440, the controller 420 requests the response message generator 450 to generate an ICMPv6 response message having the external header (IPv4 header).

In response to the request of the controller 420, the response message generator 450 specifies the universal address corresponding to the private address of the 6 to 4 router located inside the Network Address Translation (NAT) area as the destination address in the external header (IPv4 header), and generates the ICMPv6 response message to the ICMPv6 request message transmitted through the Network Address Translation (NAT) translator.

The generated ICMPv6 response message is transmitted to the Network Address Translation (NAT) translator via the packet transceiver 410, and the destination address in the external header (IPv4 header) is translated to a private IPv4 address by the Network Address Translation (NAT) translator, decapsulated by the 6 to 4 router located inside the Network Address Translation (NAT) area, and transmitted to the IPv6 host located inside the Network Address Translation (NAT) area.

According to the present invention, the mapping table for communication between the hosts is stored in the 6 to 4 router outside the Network Address Translation (NAT) area. Thus, even when a IPv6 host at a sending side is inside the Network Address Translation (NAT) area and a IPv6 host at a receiving side is outside the Network Address Translation (NAT) area, bidirectional communication is possible through the 6 to 4 tunnel.

Furthermore, the 6 to 4 scheme can be used in the Network Address Translation (NAT) area without modification of Network Address Translation (NAT) equipment and with minimized transmission delay.

While the present invention has been described with reference to exemplary embodiments thereof, it will be understood by those skilled in the art that various changes in form and detail may be made therein without departing from the scope of the present invention as defined by the following claims.

What is claimed is:

1. A method for automatic tunneling using Network Address Translation (NAT) between networks having different address formats, the method comprising the steps of:
determining whether a source address in an external header of a request message received from a host located inside a Network Address Translation (NAT) area is the same as a source address in an internal header of the request message;
when the source address in the external header is not the same as the source address in the internal header, translating the source address in the external header into a universal source address using pre-stored NAT (Network Address Translation) translation information;
storing, as mapping table entries, the universal source address and a private address extracted and translated from the source address in the internal header in a mapping table, and then transmitting the request message to a host located outside the Network Address Translation (NAT) area; and
assigning the universal address stored in the mapping table as a destination address in an external header of a response message to the request message received from the host located outside the Network Address Translation (NAT) area, and then transmitting the response message.

2. The method of claim 1, wherein, in the step of storing, as mapping table entries, the universal source address and a private address extracted and translated from the source address in the internal header in a mapping table, and then transmitting the request message to the host located outside the Network Address Translation (NAT) area, the universal source address in the external header is an IPv4 universal address of a router located inside the Network Address Translation (NAT) area, and the private address extracted and translated from the source address in the internal header is an IPv4 private address of the router.

3. The method of claim 2, further comprising, when the response message is received, the step of:
translating, by the Network Address Translation (NAT) translator, the destination address in the external header of the message into the private address and transmitting the response message to the router located inside the Network Address Translation (NAT) area.

4. The method of claim 1, wherein, in the step of storing, as mapping table entries, the universal source address and a private address extracted and translated from the source address in the internal header in a mapping table and then transmitting the request message to the host located outside the Network Address Translation (NAT) area, the mapping table comprises:
a field for storing the universal source address in the external header;
a field for storing the private address extracted and translated from the source address in the internal header; and
a deletion timer field for storing time information indicating a time when the stored mapping table entries are to be deleted after a predetermined time elapses.

5. The method of claim 4, wherein the time information stored in the deletion timer field upon storing the mapping table entries is set according to a set timer value of Network Address Translation (NAT) equipment.

6. The method of claim 5, wherein the stored mapping table entries are automatically deleted when the time information value stored in the deletion timer field becomes ‘0’.

7. A system for automatic tunneling using Network Address Translation (NAT) between networks having different address formats, the system comprising a router located outside a Network Address Translation (NAT) area for, when a source address in an external header of a request message received from a host located inside the Network Address Translation (NAT) area is not the same as a source address in an internal header of the request message, translating the source address in the external header into a universal source address using pre-stored NAT (Network Address Translation) translation information, and storing, as mapping table entries, the universal source address and a private address extracted and translated from the source address in the internal header in a mapping table, assigning the universal address stored in the mapping table as a destination address in an external header of a response message to the request message received from a host located outside the Network Address Translation (NAT) area, and then transmitting the response message.

8. The system of claim 7, wherein the router comprises:
a packet transceiver for transmitting and receiving a message to and from the hosts located inside and outside the Network Address Translation (NAT) area;
an address comparator for receiving the request message from a Network Address Translation (NAT) translator via the packet transceiver and comparing the source address in the external header of the received request message with the source address in the internal header of the request message;
a controller for determining whether address translation of the request message by the Network Address Translation (NAT) translator is made based on the address comparison result from the address comparator;
a mapping table database for storing, under control of the controller, the universal source address in the external header of the request message and the private address extracted and translated from the source address in the internal header when the controller determines that the address translation of the request message by the Network Address Translation (NAT) translator is made; and
a response message generator for assigning, under control of the controller, the universal address mapped to the private address stored in the mapping table database as the destination address in the external header of the response message to the request message, to generate the response message to be transmitted to the Network Address Translation (NAT) translator.

9. The system of claim 8, wherein the universal source address in the external header stored in the mapping table database is an IPv4 universal address of a router located inside the Network Address Translation (NAT) area, and the private address extracted and translated from the source address in the internal header is an IPv4 private address of the router located inside the Network Address Translation (NAT) area.

10. The system of claim 7, wherein the mapping table stored in the mapping table database comprises:
a field for storing the universal source address in the external header;
a field for storing the private address extracted and translated from the source address in the internal header; and
a deletion timer field for storing time information indicating a time when the stored mapping table entries are to be deleted after a predetermined time elapses.

11. The system of claim 10, wherein the time information stored in the deletion timer field upon storing the mapping table entries is set according to a set timer value of Network Address Translation (NAT) equipment.

12. The system of claim 11, wherein the stored mapping table entries are automatically deleted when the time information value stored in the deletion timer field becomes ‘0’.

13. A routing device using Network Address Translation (NAT) between networks having different address formats, the router device comprising:
a packet transceiver for transmitting and receiving a message to and from hosts located inside and outside a Network Address Translation (NAT) area;
an address comparator for receiving a request message from a Network Address Translation (NAT) translator via the packet transceiver and comparing a source address in an external header of the received request message with a source address in an internal header of the request message;
a controller for determining whether address translation of the request message by the Network Address Translation (NAT) translator is made based on the address comparison result from the address comparator;
a mapping table database for storing, under control of the controller, the universal source address in the external header of the request message and a private address extracted and translated from the source address in the internal header when the controller determines that the address translation of the request message by the Network Address Translation (NAT) translator is made; and
a response message generator for assigning, under control of the controller, the universal address mapped to the private address stored in the mapping table database as a destination address in an external header of a response message to the request message, to generate the response message to be transmitted to the Network Address Translation (NAT) translator.

14. The device of claim 13, wherein the universal source address in the external header stored in the mapping table database is an IPv4 universal address of a router located inside the Network Address Translation (NAT) area, and the private address extracted and translated from the source address in the internal header is an IPv4 private address of the router located inside the Network Address Translation (NAT) area.

15. The device of claim 13, wherein the mapping table stored in the mapping table database comprises:
a field for storing the universal source address in the external header;
a field for storing the private address extracted and translated from the source address in the internal header; and
a deletion timer field for storing time information indicating a time when the stored mapping table entries are to be deleted after a predetermined time elapses.

16. The device of claim 14, wherein the time information stored in the deletion timer field upon storing the mapping table entries is set according to a set timer value of Network Address Translation (NAT) equipment.

17. The device of claim 16, wherein the stored mapping table entries are automatically deleted when the time information value stored in the deletion timer field becomes ‘0’.
